(19) United States
(12) Patent Application Publication
(10) Pub. No.: US 2009/0113320 A1
(43) Pub. Date: Apr. 30, 2009

(54) Method and Apparatus for Generating a Graphical Interface to Enable Local or Remote Access to an Application Having a Command Line Interface

(75) Inventors: Nandakumar Gn, Bangalore (IN); Sriram Gorti, Bangalore (IN); Mohit Gupta, New Delhi (IN); Pankaj Kakkar, Bangalore (IN); Chandramouleeswaran Sankaran, Bangalore (IN)

Correspondence Address: RYAN, MASON & LEWIS, LLP, 1300 POST ROAD, SUITE 205, FAIRFIELD, CT, 06824, US

(73) Assignee: Agere Systems Inc., Allentown, PA (US)

(21) Appl. No.: 12/345,050

(22) Filed: Dec. 29, 2008

Related U.S. Application Data
(63) Continuation of application No. 10/081,874, filed on Feb. 21, 2002, now abandoned.

(51) Int. Cl. G06F 9/44; G09G 5/00

(52) U.S. Cl. 715/762

(57) ABSTRACT

A method and apparatus are disclosed for generating a graphical interface for software applications having a command line interface to enable local or remote access of such software applications in a uniform manner without regard to the location of the remote application. The location and syntax of a new software application, and any required environment settings, are specified in response to a sequence of queries. The specifications for each software application is parsed to generate a graphical client interface listing the available software applications and enabling remote access to such software applications. A desired software application is selected by a user from the client interface and the user specifies any necessary parameters for the selected software application. An input file is transferred from the client to the remote server where the selected software application is located. Any output or log files are returned to the client, for example, using the FTP protocol. The client interface permits distributed processing through a web interface and enables software applications to be accessed and used from a remote location.

### CROSS-REFERENCE TO RELATED APPLICATIONS

This application is a continuation of U.S. patent application Ser. No. 10/081,874, filed Feb. 21, 2002, incorporated by reference herein.

### FIELD OF THE INVENTION

The present invention relates generally to methods and apparatus for generating graphical interfaces for software applications, and more particularly, to methods and apparatus for generating graphical interfaces for software applications to permit remote access of the software application.

### BACKGROUND OF THE INVENTION

Computer technology continues to evolve to provide computer systems that are faster, more powerful and/or easier to use. The user interface portion of a computer system allows the user to interact with the computer system and selected application programs. In order to make computer systems more efficient and user friendly, there have been a number of advances in the user interface. Initially, most computer systems provided a command line interface that allowed a user to interact with the computer system only by entering specific, predefined commands in response to a display prompt. The computer system then parsed the entered command in accordance with defined language semantics.

An important evolution in the design of user interfaces occurred in 1984, when Apple Computer, Inc. of Cupertino, Calif. introduced the Macintosh™ operating system. The Macintosh™ operating system provides a graphical user interface (GUI) that displays a set of icons and menus on the screen and allows a user to “point and click” at a given icon or menu option to thereby initiate a desired action. For example, a user can launch a desired application by clicking on a corresponding icon on the display screen. This visual approach to user interfaces has been virtually uniformly adopted by the computer industry, especially for end-user software applications.

Nonetheless, a number of software applications still exist that are only accessible using a command line interface. This is particularly true in the area of standalone software tools that are used by software developers during the software development process, such as compilers, linkers and translators. As with the initial command line interfaces that were used in the early days of personal computers, the command line interfaces associated with these stand-alone tools are tedious to understand and utilize and require strict adherence to the language semantics.

In addition, there is currently no convenient mechanism for enabling access to such standalone applications over a network. For example, each user of the standalone software tools that are used during the software development process, such as compilers, linkers and translators, must typically have the desired software applications installed on his or her computer or local network.

A need therefore exists for a method and apparatus for automatically generating a graphical user interface for software applications having a command line interface that enables remote access of such software applications. A further need exists for a method and apparatus for enhancing the usability of software applications previously accessed locally only through a command line interface. Yet another need exists for a method and apparatus for automatically generating graphical user interfaces for software applications having a command line interface using information provided by a developer of the software application.

### SUMMARY OF THE INVENTION

Generally, a method and apparatus are disclosed for automatically generating a graphical interface for software applications having a command line interface to enable local or remote access of such software applications. A graphical user interface is automatically generated using information provided by a developer of the software application in a specified format. The generated graphical user interface allows a plurality of users to remotely access one or more software applications in a uniform manner without regard to the location of the remote application. The present invention ensures efficient and proper usage of the software applications by visually presenting only valid options to the user. In addition, a network implementation of the present invention facilitates centralized control of the licensing of each software application and distribution of the proper release of a given software application to all prospective users through a common client interface.

Initially, a developer of a software application (or another administrator) interacts with a web interface generator to add, update or delete a given software application in an application database of available software applications. The developer specifies the location and syntax (i.e., language semantics of various options and any default settings) of a new software application, and any required environment settings, in response to a sequence of queries. The provided information establishes a language definition that describes the boundary within which the software applications can be used. The application database is parsed to generate a graphical client interface listing the available software applications and enabling remote access to such software applications. The client interface can be transferred to a client, for example, in the form of an HTML web page. Once a software application is selected by a user, the corresponding information is sent to a central server. The central server asks the client to specify any necessary parameters for the selected software application. An input file is transferred from the client to the remote server where the software application is located. Any output or log files are returned to the client, for example, using the FTP protocol.

In this manner, a client interface in accordance with the present invention permits distributed processing through a web interface and enables software applications to be accessed and used from a remote location. The software applications can reside on different remote severs controlled by the main central server. The central server interacts with the client as well as the remote servers and provides an easy and secure way to handle the software applications.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 illustrates the registration of a software application with a central server and the provision of the software application to one or more users through a client interface;

FIG. 3 is a schematic block diagram showing the architecture of an exemplary central server of FIGS. 1 and 2 incorporating features of the present invention;

FIG. 4 is a sample entry from an exemplary application database of FIG. 3;

FIG. 5 is a flow chart describing an exemplary implementation of the web interface generator process of FIG. 3;

FIG. 6 is a flow chart describing an exemplary implementation of the client interface process of FIG. 3;

FIG. 7 is a sample table illustrating some of the options that are available in an exemplary software application;

FIG. 8 illustrates a web page that is employed in accordance with the present invention to obtain details about the properties of a software application to be processed;

FIG. 9 illustrates a web page that is employed in accordance with the present invention to obtain details about the properties of a set of options associated with a software application being processed;

FIG. 10 illustrates a web page that is employed in accordance with the present invention to query a user to specify various parameters for a given selected software application; and

FIG. 11 illustrates a web page that is employed in accordance with the present invention to query a user to specify various properties of input and output files for a given selected software application.

### DETAILED DESCRIPTION

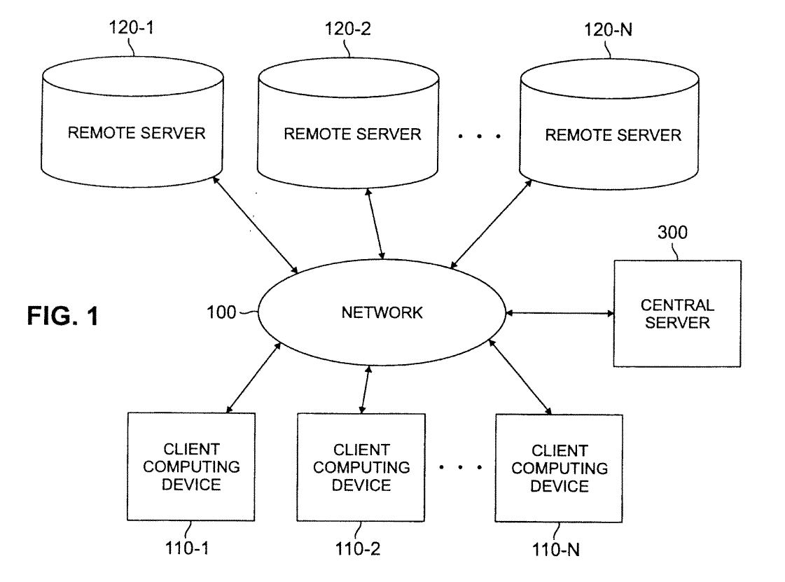

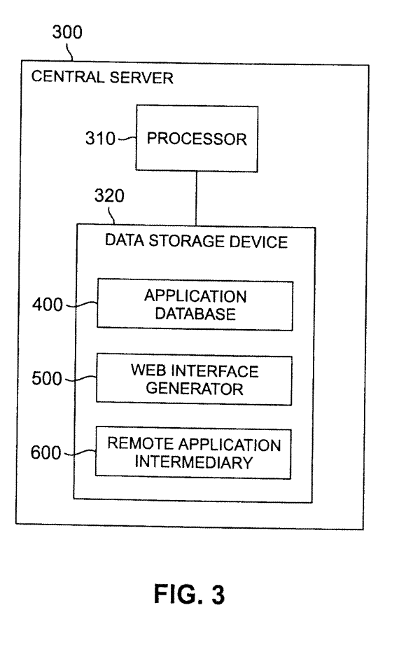

FIG. 1 illustrates a network environment 100 in which the present invention can operate. As shown in FIG. 1, one or more users each employing a corresponding client computing device 110-1 through 110-N (collectively, client computing device 110) desire to access and utilize a software application, such as a stand-alone tool, that is installed on one or more remote servers 120-1 through 120-N. A central server 300, discussed below in conjunction with FIG. 3, interacts with the client 110 and the remote servers 120 to provide a graphical client interface that allows the client 110 to access the desired application over the network 100. It is noted that while the present invention is illustrated in a distributed environment, the present invention may also be deployed on a single, stand-alone device incorporating all of the features and functions of the client 110, remote servers 120 and central server 300. It is further noted that the terms web interface and client interface are used interchangeably herein, and are both examples of a graphical user interface. Generally, the term “web interface” is primarily used in conjunction with a distributed environment implementation of the present invention and the term “client interface” is used in a more general sense to indicate a graphical interface that may be used by a client to access local or remote applications in accordance with the present invention.

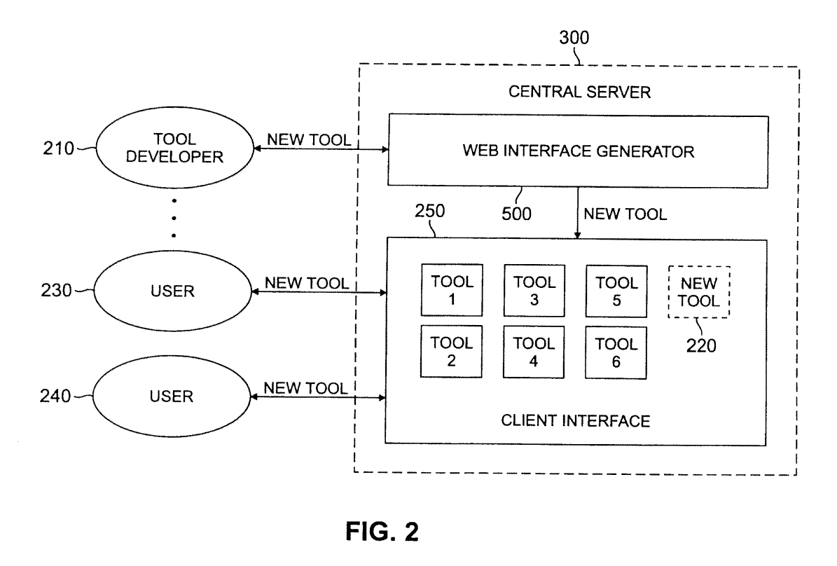

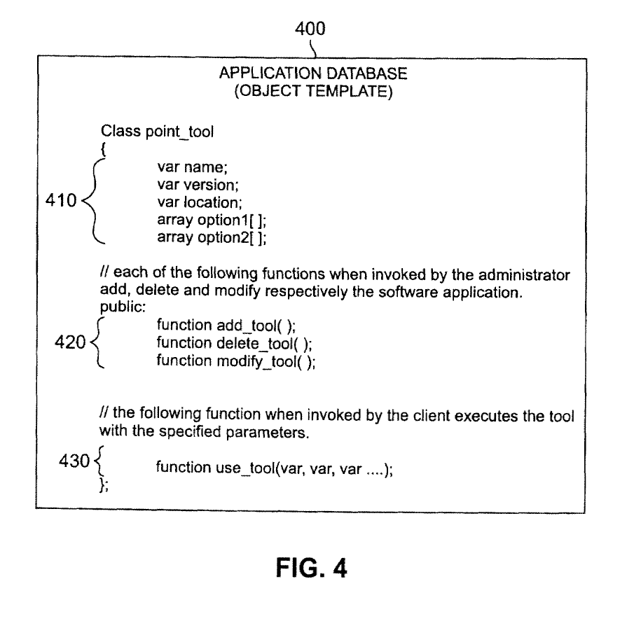

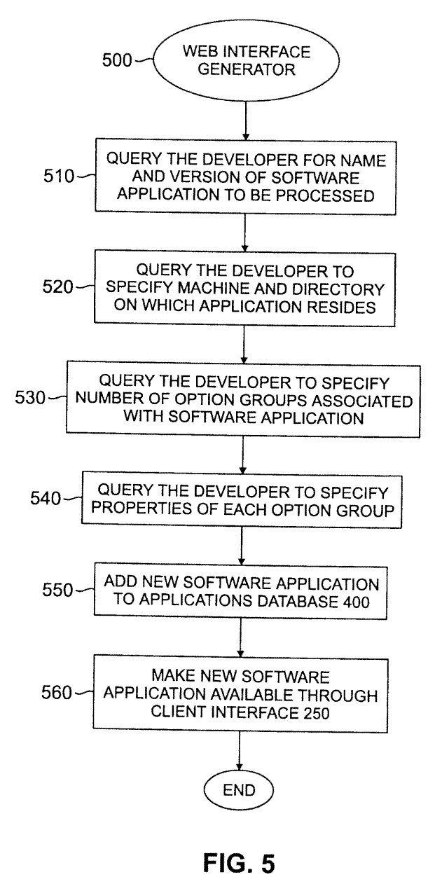

FIG. 2 illustrates the registration of a software application, referred to as a “new tool,” by a developer 210 of the software application (or another administrator) with a web interface generator 500, discussed below in conjunction with FIG. 5, of the central server 300 in accordance with the present invention. Generally, the web interface generator 500 allows an administrator to add, update or delete software applications. As shown in FIG. 2, the developer 210 interacts with the web interface generator 500 to register the new tool 220 and add the new tool 220 to a database 400, discussed below in conjunction with FIG. 4, that stores information for each available software application. The developer 210 provides the location and syntax (i.e., language semantics of various options and any default settings) of the software application, and any required environment settings, to the web interface generator 500 through a sequence of queries. This information provided by the developer 210 establishes a language definition that describes the boundary within which the software applications can be used. The database 400 is parsed to generate the graphical user interface for the software application, enabling access to remote users. Thus, as shown in FIG. 2, once the software application (“new tool”) 220 is registered with the central server 300, the software application is accessible to a plurality of users, such as users 230 and 240, through a client interface 250. In the example shown in FIG. 2, user 240 is accessing the new tool 220 through the client interface 250.

The client interface 250 contains a list of all the software applications available to the client generated dynamically by the central server 300 at the time of a request. The generated list of point tools is transferred to the client 110, for example, in the form of an HTML web page. Once a software application is selected, the information is sent to the central server 300 that responds by sending the parameter page (for that particular software application) to the client. The next step is to transfer the input file to the remote server 120 where the software application is located, for example, using client side scripting, such as Javascript. The central server 300 initiates a javascript on the client machine 110, which transfers the input file to the remote server 120 using, for example, the FTP protocol.

The web interface is interactive enough to inform the user when an error occurs while executing the software application. The client can terminate the process in between through the web interface. The log files and the output files are then sent back to the client by using the FTP or an equivalent protocol.

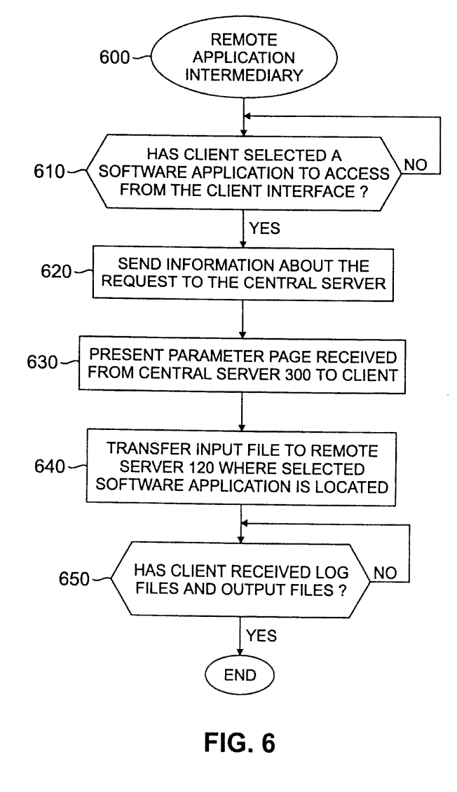

In this manner, the client interface 250 permits distributed processing through a web interface and enables the software applications to be accessed and used from a remote location. The software applications, such as the new tool 220, can reside on different remote severs 120 controlled by the main central server 300. The central server 300 interacts with the client 110 as well as the remote servers 130 and provides an easy and secure way to handle the software applications. As discussed below in conjunction with FIG. 6, this interaction is enabled by a script, referred to as a remote server script, on the corresponding remote server 120 that has the capacity to use the selected software application and return the result.

FIG. 3 is a schematic block diagram showing the architecture of an exemplary central server 300 incorporating features of the present invention. The central server 300 may be embodied as a general purpose computing system, such as the general purpose computing system shown in FIG. 3. The central server 300 includes a processor 310 and related memory, such as a data storage device 320, which may be distributed or local. The processor 310 may be embodied as a single processor, or a number of local or distributed processors operating in parallel. The data storage device 320 and/or a read only memory (ROM) are operable to store one or more instructions, which the processor 310 is operable to retrieve, interpret and execute.

As shown in FIG. 3 and discussed further below in conjunction with FIG. 4, the data storage device 320 includes an application database 400 that stores information on each application that is accessible through the client interface 250. In addition, as discussed further below in conjunction with FIGS. 5 and 6, the data storage device 320 includes a web interface generator 500 and a remote application intermediary 600. Generally, the web interface generator 500 allows a developer 210 to register a software application and add the software application to the application database 400. The remote application intermediary 600 allows one or more users to access and utilize a registered application through the client interface 250.

FIG. 4 is a sample entry from an exemplary application database 400. As previously indicated, the application database 400 records information for each software application that is accessible through the client interface 250. In the exemplary embodiment, the application database 400 is implemented as an object oriented database that models the language definitions as a Class and each software application as objects of this class. The Class has all the features related to the software application as defined by the language. As shown in FIG. 4, the application database 400 includes a Class definition section 410 that records the name, version, location (i.e., IP address of the server) and options associated with the software application. As previously indicated and discussed further below in conjunction with FIG. 5, the information recorded in section 410 is obtained from the software developer 210 in response to a set queries issued by the web interface generator 500. In addition, the information recorded in the application database 400 is utilized by the remote application intermediary 600 to allow one or more users to access and use selected software applications.

In addition, the application database 400 includes a first function section 420 that establishes functions to add, delete and modify the respective software application. Finally, the application database 400 includes a second function section 430 that establishes a “use_tool” function that, when invoked by the client, executes the tool for the specified parameters. The “use_tool” function will be discussed further below in conjunction with the remote application intermediary 600 shown in FIG. 6. This implementation of the application database 400 stores all instances of a software application in memory for future reference, thereby creating independent entities and alleviating concerns of concurrency and scheduling in a distributed processing environment. In a further variation, the information stored in the application database 400 can also be maintained in the form of data structures, as would be apparent to a person of ordinary skill in the art. In such a variation, the utility functions 420, 430 of the language are coupled with the client interface code.

Generally, each individual software application populates another copy of the generic object 400 shown in FIG. 4, which when parsed by the web interface generator 500 generates a GUI specific to this application/tool. The generic object 400 shown in FIG. 4 should be designed in a manner such that it is easily extensible and can be edited to include additional features/modifications in the application, using the web interface generator 500. If the functionality of the application changes without any changes in the command line interface, no changes are required in the graphical user interface. However, if the command line interface is modified or extended to include some additional features, the developer 210 needs to provide this information using the web interface generator 500, so that it can be comprehended in the data structure 400 for the application.

FIG. 5 is a flow chart describing an exemplary implementation of the web interface generator 500. As previously indicated, the web interface generator 500 allows a developer 210 to register a software application and add the software application to the application database 400. The web interface generator 500 may optionally only be accessed by authorized users who have, for example, been assigned a user name and password. As shown in FIG. 5, the web interface generator 500 initially queries the developer 210 or an administrator for the name and version of the software application to be processed during step 510.

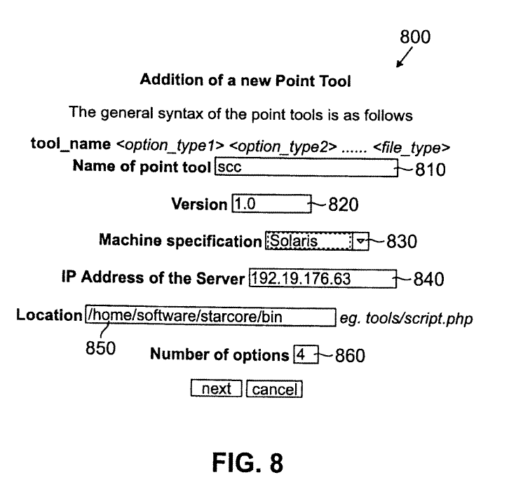

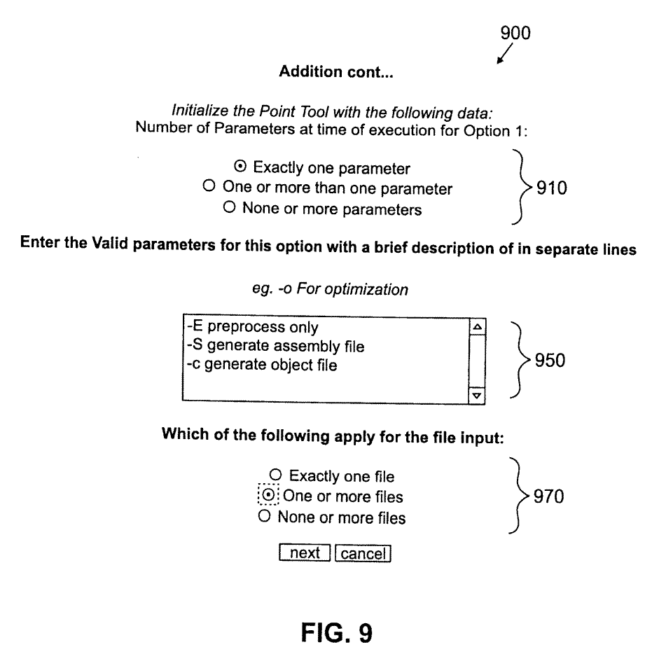

Thereafter, the developer 210 or an administrator is queried for information on the machine and directory on which the application resides during step 520. The developer 210 must specify the number of options associated with the software application during step 530. It is noted that an exemplary interface for obtaining the information associated with steps 510, 520 and 530 is discussed below in conjunction with FIG. 8. The developer is then queried during step 540 to specify the properties of each option group, i.e., for the constraints associated with a given option group, such as whether the various options within an option group can be used together and any input file requirements. A suitable interface for obtaining the information associated with step 540 is discussed below in conjunction with FIG. 9.

Once the requested information has been received, the new software application is added to the applications database 400 during step 550 and is then made available through the client interface 250 during step 560. As previously indicated, the client interface 250 contains a list of all the software applications available to the client generated, and is preferably dynamically by the central server 300 at the time of a request. The generated list of point tools is transferred to the client 110, for example, in the form of an HTML web page. Program control then terminates.

In this manner, the web interface generator 500 initializes the software application with information about its syntax, parameters, name and location. The software applications have the following general syntax:

Tool_name[option 1][option 2] . . . <filename>

where each of these options further can be of one of the following types {exactly one parameter; one or more than one; none or more and with or without an input file}. In this manner, the developer 210 or administrator can establish groups and subgroups of parameters with similar properties. There might be several sets of parameters, which are mutually exclusive and might result in a run time error on execution. This information is stored as a bit vector with the tool data. Each digit of the bit vector defines a set of mutually exclusive parameters. The set parameters that are mutually exclusive have a one (1) in their bit vector at a defined location. At the time of execution an Exclusive OR (XOR) is performed of the bit vectors to rule out the possibility of a runtime error.

The structural definition of this format of the software applications is as follows:

Struct point_tool
{

var $tool;
var $option1;

var $option2;

var $file;
var $bit_vector;

};

Where,

$tool [‘name’] = name of point tool
$tool[‘version’] = version
$tool[‘about’] = details about the point tool
$tool[‘location’] = server address of the point tool
$tool[‘loginname’] = login name for the server
$tool[‘password’] = password
$tool[‘option’] = number of types of options that can be used
$option[0...100] = all type1 options
$option[‘<option name>’] = description about the option
$option[0...100] = all type2 options
$option[‘<option name>’] = description about the option
$file = file option

In one implementation, the web interface generator 500 allows a developer to directly specify the command line syntax, when necessary, and thereby overcome a language syntax that is not specifically supported.

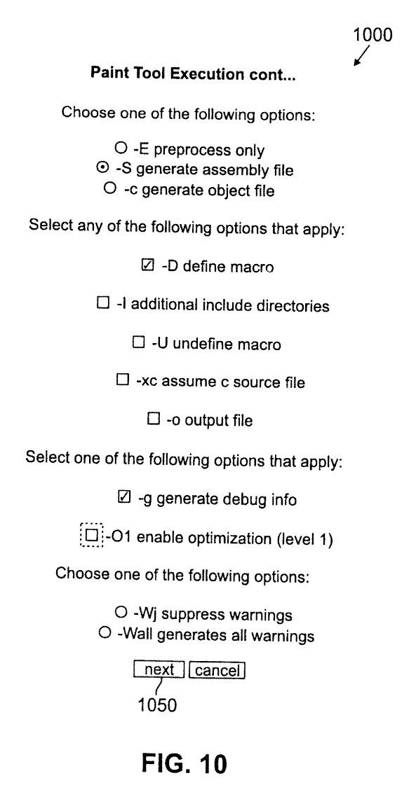

FIG. 6 is a flow chart describing an exemplary implementation of the remote application intermediary 600. As previously indicated, the remote application intermediary 600 allows one or more users to access and utilize a registered application through the client interface 250. As shown in FIG. 6, the remote application intermediary 600 initially performs a test during step 610 to determine if a client has selected a particular software application to access from the client interface 250. Once a software application is selected program control proceeds to step 620 where, the information about the request is sent to the central server 300. The central server 300 responds by sending the parameter page (for the selected software application) to the client, which is presented during step 630. An exemplary parameter page 1000 is discussed below in conjunction with FIG. 10. Thereafter, the input file is transferred during step 640 to the remote server 120 where the software application is located, for example, using client side scripting. The central server 300 can initiates a javascript on the client machine 110 to transfer the input file to the remote server 120 using, for example, the FTP protocol.

Once the log files and the output files received by the client during step 650, for example, using the FTP protocol, then program control terminates.

During execution of the remote application intermediary 600, the central server 300 interacts with the client 110 as well as the remote servers 130. This interaction is enabled by remote server scripts that reside on the corresponding remote server 120. The remote server script handles software applications and interacts with the central server 300. The central server 300 passes the arguments specified by the client 110 to the remote server script to execute the software application. Once invoked, the remote server script initializes a child process to interact with the central server request for some software application. This method of multiple processes allows several client requests to be handled simultaneously. The child process executes the software application on the server 120 and communicates the intermediate results back to the central server 300 after regular intervals.

### EXAMPLE

In order to illustrate the present invention, an exemplary StarCore™ compiler, such as the StarCore™ SC100 compiler commercially available from an alliance between Agere Systems Inc. and Motorola Inc., is the software application. Initially, the registration process is discussed, whereby the developer 210 of the StarCore™ compiler or an administrator provides the required language semantics and location details to the web interface generator 500. Thereafter, a discussion is provided of how this information is used to generate a client interface 250, which implements all the logic of the language definition and ensures correct usage.

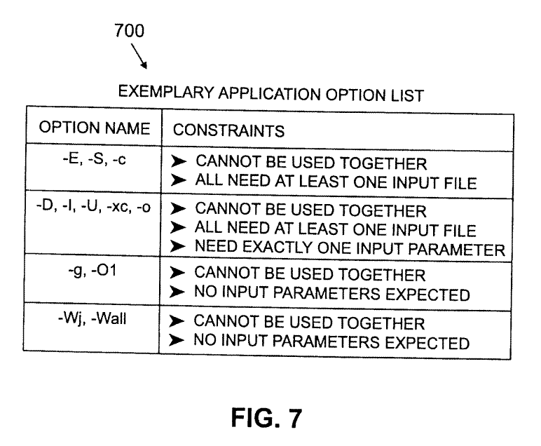

FIG. 7 is a sample table illustrating some of the options that are available in the exemplary StarCore™ compiler. In addition, for each specified option, the option list 700 indicates any associated constraints, such as whether the various options within a group of options can be used together and any input file requirements.

Once the registration process is initiated, the developer 210 or administrator is queried using an interface 800, shown in FIG. 8, for the name and version of the software application in fields 810 and 820, as well as information on the machine and directory on which the application resides in fields 830, 840 and 850. In addition, the number of options associated with the software application must be specified in field 860. It is noted that the option list 700 for the exemplary StarCore™ compiler identifies four groups of options, and the number four (4) is entered in field 860.

Once the requested information has been entered into the interface 800 of FIG. 8, the developer 210 or administrator is queried using a second interface 900, shown in FIG. 9, to specify the properties of each type of option, i.e., for the constraints associated with a given option group, such as whether the various options (identified in window 950) within an option group can be used together in field 910 and any input file requirements in field 970. It is noted that information entered in the second interface 900 corresponds to the constraints of the first option group in the first row of the option list 700 of FIG. 7.

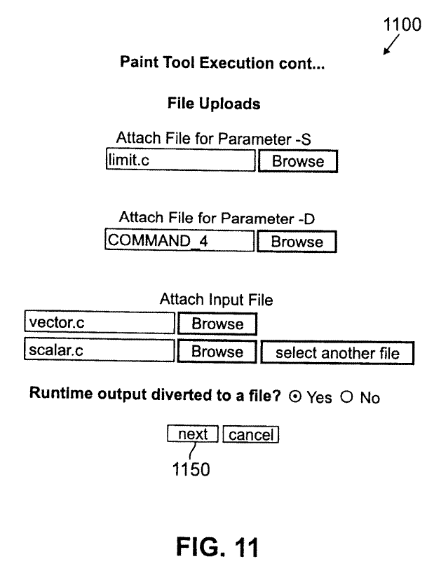

Once the entries for all the available option groups are specified using the interface 900 of FIG. 9, the new software application is added to the applications database 400 and is then available through the client interface 250. A user can select and utilize an application from the client interface 250. If the user selects the StarCore™ compiler from the client interface 250, the web page shown in FIG. 10 would be displayed based on the information previously recorded in the application database 400 for the StarCore™ compiler. The user can select from the various options of the StarCore™ compiler and submit his or her request by clicking on the “next” button 1050, resulting in display of a web page 1100, shown in FIG. 11. The web page 1100 allows the user to specify the arguments for the input files for the various option groups, as appropriate. In other words, as indicated in the option list 700 (and specified by the developer using the interface 900), input files are expected for parameters D and S. Once the user clicks on the next button 1150 in FIG. 11, the selected software application (the StarCore™ compiler in this example) is invoked on the appropriate remote server 120 and results are redirected to the user 110 in the manner specified in FIG. 11.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the embodiments and variations shown and described herein are merely illustrative of the principles of this invention and that various modifications may be implemented by those skilled in the art without departing from the scope and spirit of the invention.

We claim:

1. A method for generating a graphical interface for one or more software applications having a command line interface, said method comprising the steps of:
querying a user to specify properties of one or more option groups provided by each of said software applications, wherein said properties constrain an option group to only valid options; and
generating a graphical user interface based on said specified properties for each of said software applications, said graphical user interface identifying each of said software applications and allowing a selected one of said software applications to be accessed.

2. The method of claim 1, wherein said properties of each option group includes an indication of whether the various options within an option group can be used together.

3. The method of claim 1, wherein said properties of each option group includes an indication of any input file requirements.

4. The method of claim 1, wherein said properties of each option group includes a name of a corresponding software application.

5. The method of claim 1, wherein said properties of each option group includes a location of a corresponding software application.

6. The method of claim 1, wherein said graphical user interface allows a client to access a selected software application without regard to a location of said selected software application.

7. The method of claim 1, wherein said graphical user interface presents a client with only valid options for a selected software application.

8. A method for enabling remote access to one or more software applications having a command line interface, said method comprising the steps of:
querying a user to specify properties of one or more option groups provided by each of said software applications, wherein said properties constrain an option group to only valid options; and
generating a graphical user interface based on said specified properties for each of said software applications, said graphical user interface identifying each of said software applications and allowing one or more clients to remotely access a selected software application.

9. The method of claim 8, wherein a central server interacts with said one or more clients and a remote server where said selected software application is located.

10. The method of claim 9, wherein said central server interacts with said one or more clients and said remote server using a remote server script.

11. The method of claim 10, wherein said remote server script provides any necessary input files to said remote server, initiates the execution of said selected software application on said remote server and returns any results to said client.

12. A system for generating a graphical interface for one or more software applications having a command line interface, said system comprising:
a memory that stores computer-readable code; and
a processor operatively coupled to said memory, said processor configured to implement said computer-readable code, said computer-readable code configured to:
query a user to specify properties of one or more option groups provided by each of said software applications, wherein said properties constrain an option group to only valid options; and
generate a graphical user interface based on said specified properties for each of said software applications, said graphical user interface identifying each of said software applications and allowing a selected one of said software applications to be accessed.

13. The system of claim 12, wherein said properties of each option group includes an indication of whether the various options within an option group can be used together.

14. The system of claim 12, wherein said properties of each option group includes an indication of any input file requirements.

15. The system of claim 12, wherein said properties of each option group includes a name of a corresponding software application.

16. The system of claim 12, wherein said properties of each option group includes a location of a corresponding software application.

17. The system of claim 12, wherein said graphical user interface allows a client to access a selected software application without regard to a location of said selected software application.

18. The system of claim 12, wherein said graphical user interface presents a client with only valid options for a selected software application.

19. The system of claim 12, wherein a central server interacts with one or more clients and a remote server where said selected software application is located.

20. The system of claim 19, wherein said central server interacts with said one or more clients and said remote server using a remote server script.

21. The system of claim 20, wherein said remote server script provides any necessary input files to said remote server, initiates the execution of said selected software application on said remote server and returns any results to said client.

22. An article of manufacture for generating a graphical interface for one or more software applications having a command line interface, comprising:
a computer readable medium having computer readable code means embodied thereon, said computer readable program code means comprising:
a step to query a user to specify properties of one or more option groups provided by each of said software applications, wherein said properties constrain an option group to only valid options; and
a step to generate a graphical user interface based on said specified properties for each of said software applications, said graphical user interface identifying each of said software applications and allowing a selected one of said software applications to be accessed.
